(19) United States
(12) Patent Application Publication
(10) Pub. No.: US 2002/0090202 A1
(43) Pub. Date: Jul. 11, 2002

(54) Digital video recorder (with internet transfer/storage)

(76) Inventor: Mark Christopher Lee, Memphis, TN (US)

Correspondence Address: Mark Christopher Lee, 3995 Angelace Cove, Memphis, TN, 38135, US

(21) Appl. No.: 09/851,003

(22) Filed: May 9, 2001

Related U.S. Application Data
(60) Provisional application No. 60/253,295, filed on Nov. 28, 2000.

(51) Int. Cl. H04N 5/76

(52) U.S. Cl. 386/83

(57) ABSTRACT

The DVRi is a component that can be use in two ways. It can be a separate device. Or the DVRi can be place in other devices. The DVRi allow you to program via the phone line or web site. The DVRi can be use a in a broad range: Wireless, wireless data, internet, entertainment, high speed internet access, cable, and wired modems. The DVRi allow million of consumer to use no matter where they are. It is a device that can be use with all other devices. The purpose of the line connection is for remote programming. The DVRi utilizes a touch tone programming response system. The DVRi will also be able to use local television programming. The received signal, either analog or digital, is recorded and maintained in a compressed digital format. The DVRi also allow users to conveniently record, transfer, reproduce, and keep their own personal videos. The DVRi will store shows as they are being recorded. There will be a site that is set up through a web site provider. It would be able to program your device from anywhere and storage for later use.

The Digital Video Recorded (with internet transfer/storage capabilities) will from henceforth be referred to as the DVRi.

Current technology limitations:

(1) People often leave home and forget to set their VCR to record a special or their favorite show.

(2) People have lots of video tapes that:

(a) Take up space.

(b) Sit on a shelf, collect dust, get old and the video quality diminishes.

(c) They want to make multiple copies of to send to friends and family.

(d) Are becoming outdated with the emergence of newer video formats.

Purpose of the DVRi

(1) The DVRi is a device, which connects directly to your TV, cable box, or satellite receiver. The DVRi device also connects to your phone line. The purpose of the phone line connection is for remote programming while away from home and possible software updates. Programming can be done in one of two ways. The DVRi can be programmed by simply calling your own home phone number, and utilizes a touch-tone programming response system. Programming method two is done by logging on to the DVRi website and selecting desired programming. The DVRi will also be able to use VCR+programming codes. Recording is accomplished using a digital format (to be determined). The received signal, either analog or digital, is recorded and maintained in a compressed digital format.

(2) The DVRi also has standard RCA audio/video input/output, as well as an s-video input/output for clearer picture quality. There is also the possibility the DVRi having a direct digital input/output. The purpose of this is for direct digital audio/video transfer and storage. Any standard a/v device, such as VCRs, camcorders, and etc could be directly connected to the DVRi. The DVRi would then take the current analog/digital media format and convert it to a compressed digital file format, i.e, MP2 or asf.

(3) Depending upon the DVRi model, DVRi files can be recorded/stored via video capture hard drive, recordable DVD, other recordable disc media The DVRi will also utilize a USB connection to transfer files to a users own online storage site, i.e. Freedrive.com. Files previously uploaded by the DVRi can also be retrieved. Other non-DVRi files can be downloaded and played depending upon file type. It is strongly recommended that all files that are downloaded to the DVRi are first downloaded to the user's pc, and checked for any viruses. It is also recommended that when using the Internet to upload/download files, a high-speed internet connection be used, such as cable modem, ISDN, DSL, or TI, due to large file sizes and transfer times.

(4) As newer digital video formats appear, the DVRi will receive software upgrades. These upgrades are made to keep the DVRi hardware as technologically current as long as possible and to maximize the consumer's investment. Upgrades can be received via phone line connection. Phone line upgrades would be done during off peak phone usage times or at a specific time as determined by the user. Users who prefer upgrades via pc USB port can periodically check the website for software version upgrades.

(5) The idea behind the DVRi is to allow users to conveniently record, transfer, reproduce, and keep their own personal videos for private usage. We do not promote or condone the use of DVRi technology for any unlawful reproduction. Distribution, or exhibition of any copyrighted material. In any event of this infringement DVRi technology will not be held responsible. Any user utilizing this system in ways other than its intended use will be held solely responsible for all applicable penalties and fines.

(6) The DVRi will cover it all from wireless, DVD's, VCR's, satellite, internet, high speed cable internet, digital cable, fiber optic, and pc built in the television. So that you would be able to record with or without a tape or CD. The DVRi will allow you to record on pc.

What I claim as my invention is:

1. There are so many people who leave home and forget to program there VCR's or DVD's to record there favorite show or a special they want to see. Or they do not have a tape or CD to use. The DVRi has multiple functions that would solve there problems. With the DVRi you would be able to do just that by calling home and using your phone line or using the internet.
